(19) United States
(12) Patent Application Publication
(10) Pub. No.: US 2020/0265478 A1
(43) Pub. Date: Aug. 20, 2020

(54) System and Method for Frequency Capping Across Multiple DSPs

(71) Applicant: Kinesso, LLC, New York, NY (US)

(72) Inventors: William Lyman, Nashville, TN (US); Chris Manolarakis, New York, NY (US)

(21) Appl. No.: 16/729,634

(22) Filed: Dec. 30, 2019

Related U.S. Application Data
(60) Provisional application No. 62/786,526, filed on Dec. 30, 2018.

(51) Int. Cl. G06Q 30/02

(52) U.S. Cl. CPC G06Q 30/0275; G06Q 30/0242; G06Q 30/0269; G06Q 30/0277

(57) ABSTRACT

A system and method for frequency capping across multiple DSPs based on a global frequency cap for all DSPs, wherein a particular DSP determines whether a target user has reached a global frequency cap across all DSPs based on (a) the actual number of ad displays the particular DSP has delivered to the target user and (b) the estimated number of ad displays that have been delivered to the user by the other DSPs, which is estimated using a Markov chain and Poisson probability analysis that determines the probability the target user is in each of a plurality of DSP universes and the likely rate of ads delivered in each universe to find the amount of time spent in each universe and the ads seen in each universe.

### CROSS REFERENCE TO RELATED APPLICATIONS

This application claims the benefit of U.S. Provisional Patent Application No. 62/786,526, filed on Dec. 30, 2018, and entitled “Frequency Capping Across Multiple DSPs.” Such application is incorporated by reference herein in its entirety.

### STATEMENT REGARDING FEDERALLY SPONSORED RESEARCH OR DEVELOPMENT

Not applicable.

### BACKGROUND OF THE INVENTION

When deploying a programmatic digital ad campaign, the frequency cap is a useful tool to prevent the campaign from purchasing and showing too many ad displays to a single user. Within a given campaign aimed at a given demographic group of users, the advertiser, as part of the bid algorithm it submits to the Demand Side Platform (“DSP”), sets a cap on the number of ad displays that will be served to a single user over the course of one day. This prevents both (1) additional ads accruing purely negative value, as the user gets annoyed at seeing the same ad repeatedly, and, short of that, (2) additional ads accruing negative net value from the ad value diminishing over multiple views and eventually falling below their cost.

When using multiple DSPs for a given campaign, implementing a campaign-wide frequency cap is problematic. Each DSP does not know what the other is doing in real time (nor is it simple to coordinate them, even allowing for some latency, under existing structures), and therefore does not know how many times a user has viewed a given ad over the course of the day across all DSPs. For example, if an advertiser is running a campaign on two DSPs, and it wants to cap a given demographic segment at ten ad views per day, it could simply cap each DSPs views at five for the day. The advertiser, however, does not know that a given user will spend his or her time such that exactly—or even approximately—50% of his or her ad views will be processed by each DSP. As a result, a user might hit the 5-view cap set for one DSP very quickly, while getting zero or very few views on the other DSP, and grossly under-hit the 10-view intended global cap. The same problem applies to setting the two DSP frequency caps by budget allocation.

The above-described problem is one of incomplete information. A successful frequency cap operates as a decision algorithm: “if this user has seen k or more ads already, do not bid; and if this user has seen fewer than k ads already, bid.” This decision requires knowledge of the total number of views already served to an individual user at the point in time and the node in the system that the decision is made, which in practice today is inside each individual DSP's bid algorithm. While this total knowledge is required, the information in the system useful for achieving total knowledge is, unfortunately, segregated on two key dimensions. First, the information is segregated by DSP location in that the various DSPs do not share information between them, so that a particular DSP only knows a portion of the total ads the user has seen—i.e., only those for which the particular DSP has processed the bid. Moreover, a particular DSP does not know a predictable function by which its available information (the ads it has processed) maps to the relevant information (the total ads seen by the user). Second, while the advertiser does receive information from each of the DSPs on all ad deliveries (e.g., event logs) and provides information to each of the DSPs on how to bid (e.g., bid instruction algorithm), this information is segregated in time. That is, the advertiser receives the event logs from the DSPs only at the end of each day (or at a small number of discrete periods within a given day) and submits the bid instructions to the DSPs only at the beginning of each day. These restrictions isolate the “bid/do not bid” decision to a point in the system lacking necessary information on the total number of ads served to the user that day.

What is needed is a solution that can, within these restrictions, provide each DSP with as much relevant information as possible for the bid/no bid decision, at each beginning of day via the bid algorithm, so that the DSP can make optimal decisions using the information it receives during the day, i.e., the record of bid events that it processes. To do this, the advertiser can in turn use the past event logs received from the DSPs at the end of prior days, as explained more fully below.

### BRIEF SUMMARY OF THE INVENTION

Generally speaking, the present invention is directed to a system and method for frequency capping across multiple DSPs based on a global frequency cap spanning all DSPs. The system and method of the present invention allows a particular DSP to determine whether a target user has reached a global frequency cap in a day across all DSPs based on (a) the actual number of ad displays that the particular DSP has delivered to the target user in that day and (b) the estimated number of ad displays that have been delivered to the user in that day by each other DSP. This estimated number of ad displays in other DSPs is determined using a probability analysis based on audience information (such as demographic information) and user activity (such as records of the user being served ad impressions on various digital properties at particular times and dates). Because the way in which advertisers utilize DSPs, a mapping from each possible digital property on which a user will be served an ad impression and the DSP that will process such impression's bid opportunity are generally known. Based on the probability of the user visiting digital properties serviced by specific DSPs over time, the amount of time that a user will spend in a state in which it may be exposed to ad impressions processed by each DSP can be modeled. Similarly, the rate at which ad impressions will arrive to the user in each such state can also be modeled. Combining these two models, a model providing the number of ads displayed to the user by each DSP on a given future day can be created.

From this model a solution in two primary possible embodiments can be output. First, running the model offline, a vector of DSP-specific frequency cap values that will result in the optimal number of total ad impressions across all DSPs can be provided. Alternatively, running the model in real time, a given DSP can update its belief on the expected number of ad impressions the user has seen elsewhere and accurately halt further bids for impressions to the user when the estimated total number of impressions hits the global cap number. This allows the current DSP to determine what bid response to send in response to a bid request. These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a diagram representing the communicative relationship between an advertising agency and DSPs, where information is transferred between the agency and each separate DSP in a segregated manner.

FIG. 2 is a diagram depicting a third embodiment of the present invention, where a bid request is received at a DSP and the DSP calls upon a direct query service to perform the probability analysis of the present invention to provide the DSP with information necessary to make a bid decision in response to the bid request.

FIG. 3A-1 is a first section of a flow diagram depicting the alternatively real-time use embodiment of the present invention, that together with FIGS. 3A-2, 3B-3C show the use of neural networks to produce statistical parameters and statistical models (a Markov Chain and a Poisson process) to model the user's movement across states, which can be used for making a bid/no-bid decision.

FIG. 3A-2 is a second section of a flow diagram depicting the alternatively real-time use embodiment of the present invention, that together with FIGS. 3A-1, 3B-3C show the use of neural networks to produce statistical parameters and statistical models (a Markov Chain and a Poisson process) to model the user's movement across states, which can be used for making a bid/no-bid decision.

FIG. 3A depicts the interrelationship between FIGS. 3A-1 and 3A-2.

FIG. 3B is a third section of a flow diagram depicting the alternatively real-time use embodiment of the present invention, that together with FIGS. 3A-1, 3A-2, and 3C show the use of neural networks to produce statistical parameters and statistical models (a Markov Chain and a Poisson process) to model the user's movement across states, which can be used for making a bid/no-bid decision.

FIG. 3C is a fourth section of a flow diagram depicting the alternatively real-time use embodiment of the present invention, that together with FIGS. 3A-1, 3A-2, and 3B show the use of neural networks to produce statistical parameters and statistical models (a Markov Chain and a Poisson process) to model the user's movement across states, which can be used for making a bid/no-bid decision.

FIG. 4 is a chart depicting the time the user has spent in DSP Universe i over time.

FIG. 5 is a chart depicting the time the user has spent in DSP Universes i and j over time.

FIG. 6 is a chart depicting the time the user has spent in DSP Universes i, j, and k over time.

FIG. 7 is a diagram illustrating one embodiment of digital properties separated into DSP Universes.

FIG. 8 is a diagram illustrating one embodiment of digital properties separated into DSP Universes and representing the user's position at time t.

FIG. 9 is a diagram illustrating one embodiment of digital properties separated into DSP Universes and representing the user's position at time t+1.

FIG. 10 is a diagram illustrating one embodiment of digital properties separated into DSP Universes and representing the user's position at time t+2.

### DETAILED DESCRIPTION OF THE INVENTION

Generally speaking, the present invention is directed to a system and method for intelligently setting a frequency cap for each campaign segment of an ad campaign in order to optimize the tradeoff between the value gained from ad displays up to the cap number and the value lost from displays going over the cap number, including by optimally creating additional campaign segments to group users likely to share outcomes in the model. The probabilistic model outputs a “Decision Probability”, or the probability that the given user has not hit the intended global frequency cap over all DSPs, given only the information available at the point and time of decision, which is inside the one individual DSP being queried to bid at a time that the user is viewing the ad display. The decision probability can be calculated using Equation 1 below:

Decision Probability=P(userₖ has not hit the global frequency cap|information available inside DSPᵢ) Equation 1:

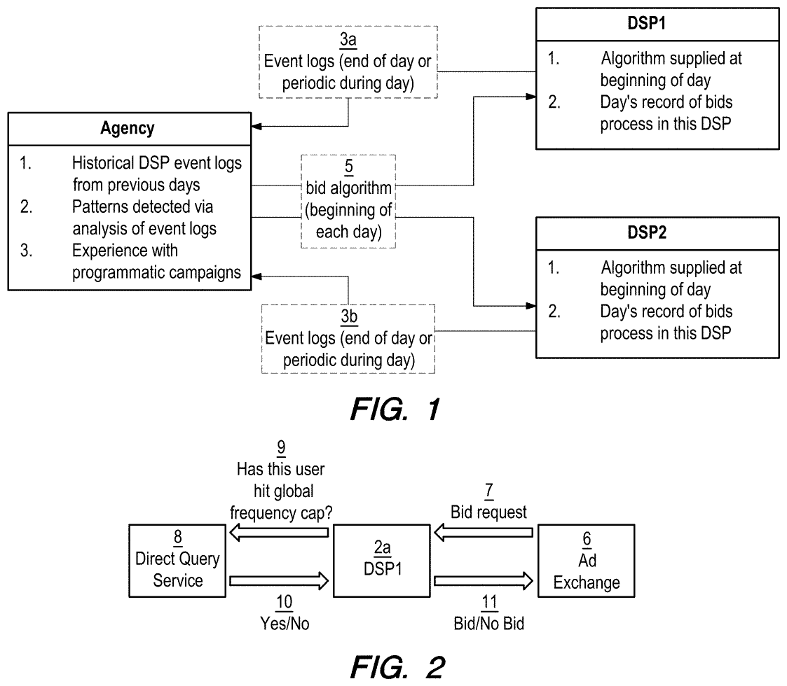

As shown in FIG. 1, which depicts information segregation, the information available to the particular DSP 2a, 2b includes (a) the bid algorithm 5 provided to the DSP 2a, 2b by the agency 4 at the beginning of each day and (b) a record 3a, 3b of the bids processed by the given DSP 2a, 2b during that day. Of course, (c) the time of day at which the decision is being queried is also available information. This decision probability allows a particular DSP 2a to determine whether it should send a bid decision 11 (which may be a bid response or a no-bid response, for example) in response to a bid request 7 from an ad server 6 (as discussed more fully below, and as shown in FIG. 2) based on the determined likelihood that the user has or has not reached a global frequency cap—such determination being made based on the probability analysis discussed below.

Separately, based on commercial estimates of the value gained and lost from ad displays up to and over the cap number, the present invention incorporates a Decision Probability threshold level (the “Decision Threshold”), over which the DSP will bid and under which it will not bid. In some cases, with these two pieces of information the present invention is able to determine a “bid/no bid” action by the DSP, using the following Decision Rule 1:
Decision Rule 1:
Decision Probability>Decision Threshold⇒Bid
Decision Probability≤Decision Threshold⇒Not Bid

In this case, the bid decision of the DSP may be binary and the response may simply be a “bid response” or a “no-bid response”. Alternatively, for bid algorithms that are capable of it, the probability can map directly to a continuous increase in the bid amount, rather than merely dictating a binary bid/no bid decision. For example, the algorithm may assign bid amounts as shown in Table 1:

TABLE 1

| Decision Probability | Bid Amount |
|---|---|
| [0%, 65%] | $0.00 |
| [65%, 75%] | $0.25 |
| [75%, 85%] | $0.35 |
| [85%, 90%] | $0.45 |
| [90%, 100%] | $0.55 |

In this case, the bid decision is not simply a “bid” or “no-bid” but bid amounts are dictated by the calculated decision probability. The conditional structure of the Decision Probability measure will allow ever-more fine-grain data to be incorporated into it as additional “givens,” allowing for ever-more precise probability measure outputs. Such data may consist of individual user characteristics or histories, real-time event data, etc.

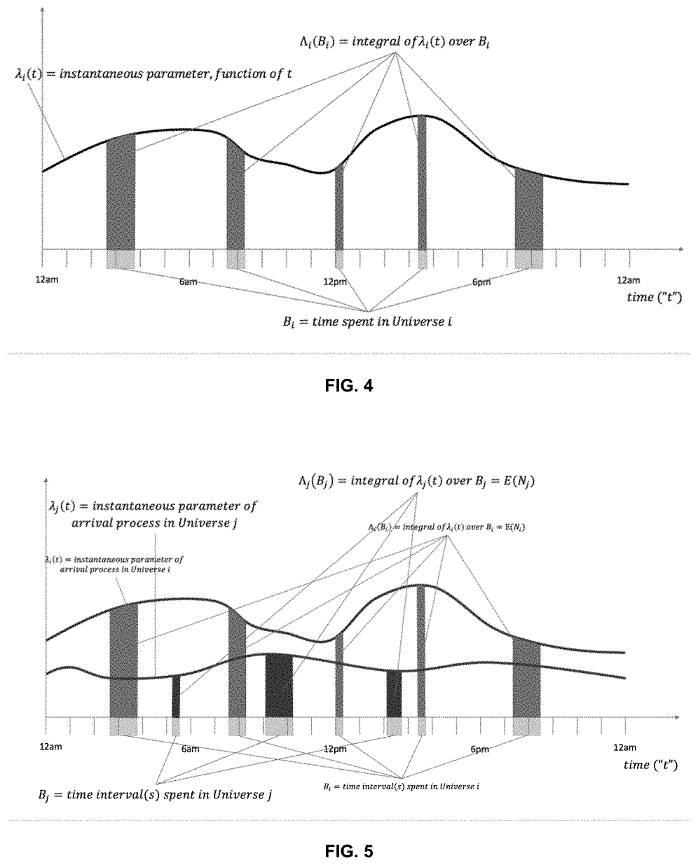

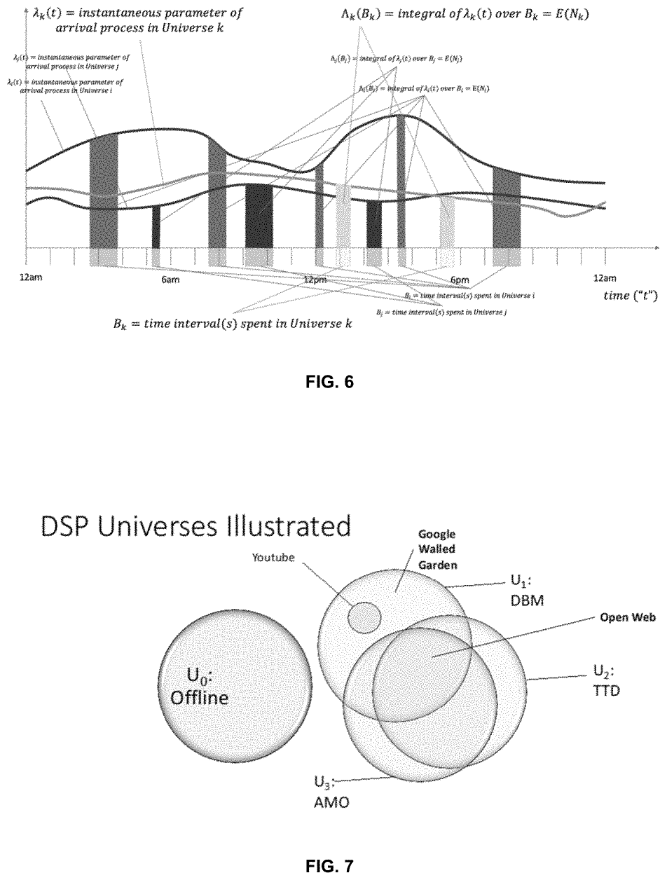

The basic insights underlying the present invention include the following. First, digital properties can be partitioned into “DSP Universes”, each DSP Universe consisting of the properties of ad displays served by a given DSP. There may be overlap among such DSP Universes, but the extent of properties served by each DSP is known and fixed. Further, bids taking place within an overlapping space will be handled by the various DSPs according to a known probability distribution. Examples of DSP Universes and movement within these universes are shown in FIGS. 7-10. As shown, for example, various digital properties may be grouped into different universes for different DSPs—DBM, TTD, and AMO. Another universe may correspond to the user being Offline. These DSP Universes are discussed more fully below. FIG. 4 provides an example of a user within a particular Universe i. FIG. 5 overlays the user movement in Universe i with Universe j. FIG. 6 adds Universe k.

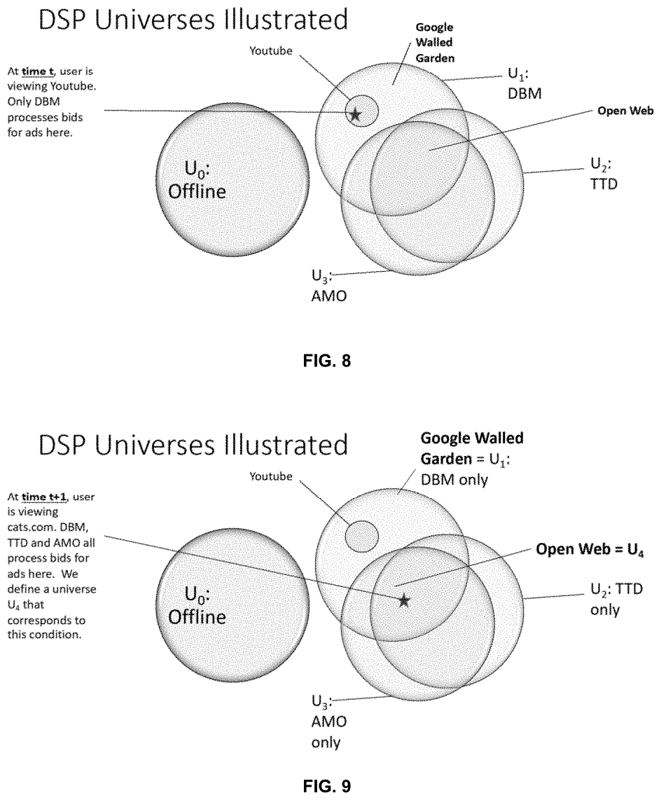

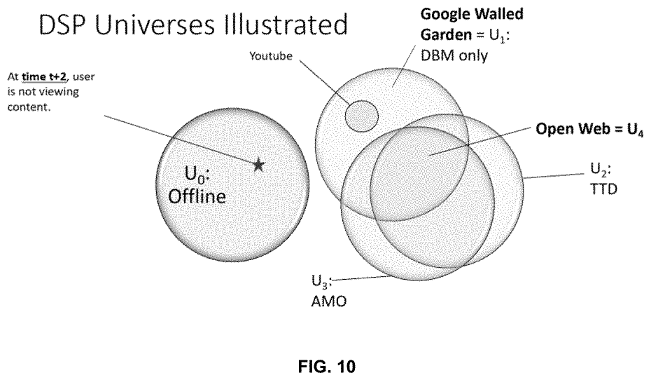

Second, it is understood that a user will spend his or her day moving among many states, and in each state the user will be either viewing one of many digital properties or not viewing a property. As noted above, each such property belongs to one or more DSP Universes. As shown, for example, in FIG. 7, the digital property YouTube is in Universe 1 (U1) corresponding to only DBM, while cats.com is in overlapping DSPs—that is, DBM, TTD, and AMO all process bids for ads for that digital property. This overlapping area may be assigned its own universe (U4), as shown. FIGS. 8-10 illustrate movement through these digital properties over time. FIG. 8 shows the user viewing YouTube at time t, where only DBM may process bids because of the “walled garden” nature of this content. FIG. 9 shows the user at time t+1 viewing cats.com, where as previously noted multiple DSPs may bid as illustrated by the overlapping Venn bubbles. FIG. 10 illustrates the user at time t+2, at which point no content is being viewed.

Third, a user's movement among these states can be modeled with a Markov chain, and therefore, the user's movement among DSP Universes can be modeled. A Markov chain is a matrix of “transition probabilities” of the form

P (user will be in DSP Universe j at t+1|user is in DSP Universe i at t) which is the probability that the user will be in one specific DSP Universe at the next moment, given that the user is in another specific DSP Universe at the current moment. The matrix of probabilities will take the following form, where the above probability is denoted by

$$[ \begin{matrix}{P}_{1 , 1} & {P}_{1 , 2} & … & {P}_{1 , n} \\ ⋮ & ⋱ & ⋱ & {P}_{2 , n} \\ {P}_{n - 1 , 1} & ⋱ & ⋱ & ⋮ \\ {P}_{n , 1} & … & {P}_{n , n - 1} & {P}_{n , n}\end{matrix} ]$$

Fourth, it is also known that the delivery of ad displays to a user while that user is in a given DSP Universe is an arrival process that can be modeled by a Poisson distribution that will describe an expected rate of ad displays per time and variance of such rate. The ad view arrival process for each DSP Universe can be defined by a variable parameter λᵢ(\vec{x}, t), denoting the average number of ad displays over a given amount of time, where x is a vector of data points describing the campaign, the user's demographic and other characteristics, and the properties in the DSP Universe, etc., and t is the time of day.

Fifth, the total number of ad views a user will be served over time by combining (1) a model of the time a user spends in each DSP Universe and (2) a model of the rate at which a user will be served ad views in each DSP Universe.

Sixth, users are separated into demographic segments, and a digital ad campaign (and bid algorithm) is built to serve a single segment. The users in a given segment will share behavior characteristics which leads to them sharing characteristics both in their own viewing behaviors and in how ads are delivered in the properties they view.

Finally, a Markov chain and Poisson distribution parameters—the {P_{i,j}} and the λᵢ( [symbol] , t)—can be constructed using data from research on user behaviors and ad serve patterns.

As noted above, the model underlying the Decision Probability calculation is a Markov-Modulated Poisson Process (“MMPP”). The MMPP produces a probability distribution of the number of ad displays viewed by a user at a given time t. The total ad displays for a user in a day processed by all DSPs is a sum of the ad displays processed by each DSP, as shown in Equation 2:

$$total ad displays viewed by user k = {\sum }_{DSPs i} ( ad displays to user k processed by {DSP}_{i} ) \qquad Equation 2$$

The number of ad displays to a given user processed by a given DSP is the product of the time spent by the user in the DSP Universe and the rate of ad displays in that DSP per unit time, as shown in Equation 3:

ad displays to user k processed by DSP=(time spent on DSPᵢ)×(ad displays per time spent on DSPᵢ) Equation 3

Combining Equations 2 and 3, the total number of campaign ad displays to a given user across DSPs is calculated with Equation 4:

$$total ad displays viewed by user k = {\sum }_{DSPs i} = ( time spent on {DSP}_{i} ) \times ( ad displays per time spent on {DSP}_{i} ) \qquad Equation 4$$

A system according to certain embodiments the present invention models the distribution of the first term of this product from the Markov chain model and the distribution of the second term of this product from the Poisson arrival process model. As a result, it produces an estimate of the total ads served to a user, ostensibly broken down by DSP Universe. It further produces a set of DSP-specific frequency caps for each demographic slice, and can be incorporated into the bid algorithm sent to each DSP at the beginning of each day in order to update the Decision Probability in real time based on data present inside each given DSP. From the Markov transition matrix, the probability distribution of the total amount of time the user will spend in a given DSP Universe over the course of a day may be calculated. This quantity will be a random variable Tᵢ for each DSP Universe i. In parallel, the system models the frequency at which ad displays are served to a given within a given DSP Universe with a Poisson arrival process, which produces the expected number of ad displays to a given user per time spent in the given DSP Universe by that user. The parameters of the Poisson process may be constructed using user and Web behavior data, including mean and variance measures. The Markov and Poisson models are discussed in more detail below, along with their combination into the ultimate Decision Probability.

The system allows for intra-day updating. Having modeled the distribution of user ad displays among DSP Universes, the system may then instruct the individual DSP (via the bid algorithm) to interpret the real-time behavior of a given user against this distribution. If a given user is recording ad serves in the given DSP Universe at a higher rate than the model expects, the algorithm in that DSP infers that that user is spending more time than expected within its DSP Universe, and conversely that it is spending less time than expected in the other DSP Universes, or

$$time spent on {DSP}_{j \neq i} ∝ \frac{1}{ad serves on {DSP}_{i} - 𝔼 ( ad serves on {DSP}_{i} )}$$

By Equation 2, a user recording more ad displays than expected in the given DSP Universe will thus revise downward the modeled number of ad displays occurring on the other DSPs and, by Equation 3, the modeled total number, decreasing the Decision Probability. A slower than expected ad display rate for a given user will have the opposite effect.

As noted above, the present invention utilizes both a Markov chain model and a Poisson arrival process model. The central structure in the Markov chain model is a transition matrix P made up of the probabilities that a given user will be in DSP Universe j at time t+1 given that the user is in DSP Universe i at time t. Where such probability is represented by P_{i,j}, and for n DSP Universes:

$$P = [ \begin{matrix}{P}_{1 , 1} & {P}_{1 , 2} & … & {P}_{1 , n} \\ ⋮ & ⋱ & ⋱ & {P}_{2 , n} \\ {P}_{n - 1 , 1} & ⋱ & ⋱ & ⋮ \\ {P}_{n , 1} & … & {P}_{n , n - 1} & {P}_{n , n}\end{matrix} ]$$

A discussion of the development and construction of this transition matrix, and a discussion of how the matrix is utilized, is provided more fully below. There are three major DSPs, and the ad displays on each digital property are served by one, two or all three of them. Where more than one DSP serves the ad displays on a property, the probability, within a given demographic slice, of each DSP being called upon to process the bid for a given account is known. Therefore, a separate DSP Universe for each set of such probabilities that exists must be created.

The ability to construct a model of transition probabilities is based on the nature of user behavior as it relates to movement across digital properties. To construct the transition matrix P a transition matrix Q of the transition probabilities of a user across properties is created. Because the relationship of DSPs servicing bids for ad views appearing on different properties is known, P can be derived from Q. Q will not appear explicitly in the model once the shape of P has been determined and Q is thus a Hidden Markov chain. For a given demographic slice, there are a finite set of digital properties with meaningful rates of visiting by users in the slice. For each such slice the required Q may be built.

The present invention may also derive the time in each state from the transition matrix. Time is treated as a discrete phenomenon, and thus, the amount of time a user spends on a given property is a product of the long-term average of being on that property at a given time interval and the total amount of time over which the user is being monitored (in the same way that the number of times a coin comes up heads will be a product of the probability of a given flip coming up heads and the total number of flips):

Bⱼ=Pⱼ×B_{G}

where Bⱼ is the time spent in state j, Pⱼ is the constant probability of being in state j at any given instant, and B_{G} is the total amount of time being considered (“G” is used to denote “Global”). Because the transition matrix represents a regular Markov chain, after a sufficient number of periods, Pⱼ is given by:

$${P}_{j} = {lim}_{n \to ∞} {( {P}^{n} )}_{i , j}$$

where the entries of column j in a regular Markov chain converge to a single value. For a matrix P, Pⁿ is given by:

$${P}^{n} = \frac{1}{n} {\prod }_{k = 1}^{n} P$$

where the product operator represents a matrix product. A matrix product is given by the following equation:

$$For ( n \times n ) square matrices A , B and C such that A \times B = C , \\ {c}_{i , j} = {\sum }_{k = 1}^{n} {a}_{i , k} {b}_{j , k}$$

### Therefore

$${P}_{i , j}^{2} = {\sum }_{k = 1}^{n} {p}_{i , k} {p}_{j , k}$$

In addition to this Markov model, a Poisson model is also used to derive the number of views, including views in a single DSP Universe and total views across all Universes. For views in a single DSP Universe i, the parameter λᵢ( [symbol] , t) denotes the average number of ad serves per a unit time. The parameter is itself a variable, which takes as its arguments several data points describing the function of the ad displays within that DSP Universe, the level of match between the campaign's targeted users, the user considered and the properties within the given DSP Universe (collectively represented in the vector [symbol] ) and the time of day (t). The Poisson distribution defines the probabilities of every possible number of events occurring within a given time interval B as shown in Equation 5:

$$P ( {N}_{i} = n ) = \frac{{{Λ}_{i} ( B )}^{n}}{n !} {e}^{- {Λ}_{i} ( B )} \qquad Equation 5$$

where Nᵢ is the random variable representing the number of ad views shown to the user over the time interval considered (here, Bᵢ, explained below) in DSP Universe i; n is any given value that Nᵢ can take; and Λᵢ(Bᵢ) is the integral with respect to time of the parameter λᵢ( [symbol] , t) over the time interval Bᵢ that the user spends on DSP Universe i.

Integration is used to find Λᵢ(Bᵢ) because λᵢ(\vec{x}, t) is a non-stationary Poisson parameter, in that its value will continuously vary throughout the day, as traffic levels vary as a function of time. \vec{x} is the vector of input variables that shape the value of λᵢ(\vec{x}, t) at a given moment in time. The relationship of the λᵢ(\vec{x}, t) value to the \vec{x} values is fixed at a given value of t, or is “stationary” on \vec{x}. By construction of the Poisson distribution, the value of the parameter Λᵢ(Bᵢ) represents both the expected value and the variance of Nᵢ(Bᵢ). These values allow for the development of a model of the distribution of Nᵢ(Bᵢ). Λᵢ(Bᵢ) is calculated as follows:

$$\begin{matrix}{Λ}_{i} ( {B}_{i} ) = {\int }_{{t}_{0}}^{{t}_{1}} {λ}_{i} ( \vec{x} , t ) dt & Equation 6 \\ where {B}_{i} = [ {t}_{0} , {t}_{1} ] & \end{matrix}$$

In this equation, the \vec{x} values are fixed parameters with deterministic values. The task is therefore to define the function λᵢ(\vec{x}, t) as a mapping of the \vec{x} values and of t that produces a valuable and accurate model quantity Λ(B) via Equation 6. For total views across all DSP Universes, the function by which the vector of data points \vec{x} maps to a usable parameter λᵢ(\vec{x}) is determined by machine learning on a training set.

The Poisson Parameter may be derived from available data. The bid algorithm combines the information the given DSP receives during the day (i.e., the actual bids processed and ads displayed for each given user) with its model of the number of ads the user has seen in other DSP Universes. The bid algorithm maintains a running cumulative distribution function (“CDF”) of the total number of ads the user has been served, represented as F_{ads}(n). For a given DSP Universe, this function takes the form shown in Equation 7:

$${F}_{D S {P}_{j}} ( n ) = P ( user has seen fewer than n ads on {DSP}_{j} ) = P ( {N}_{i} ( {B}_{i} ) < n ) = {\sum }_{i = 1}^{m} \frac{{{Λ}_{i} ( {B}_{i} )}^{i}}{i !} {e}^{- {Λ}_{j} ( {B}_{i} )} \qquad Equation 7$$

where Bᵢ is the time interval over which we are measuring ad views on DSP Universe i, and N(Bᵢ) is the number of ads viewed within the time interval Bᵢ. The value sought by the MMPP is a combination of the CDFs of the several DSP Universe-specific Poisson variables, or the probability that the user has seen fewer than n ads on all DSPs:

$${F}_{G} ( n ) = P ( user has seen fewer than n ads over all DSPs ) = P ( {\sum }_{i = 1}^{m} {N}_{i} ( {B}_{i} ) < n )$$

where F_{G}(n) indicates the CDF for the “Global” number of ad views for the user across all DSP Universes.

This is the probability that the sum of the Poisson variables from all DSPs is less than the number n, where m is the number of individual DSPs considered, Nᵢ(Bᵢ) is the number of ad views on DSP i during the time interval Bᵢ that the user spends in DSP Universe i, and n is the number of ad views at which we set our cap. A convenient characteristic of Poisson variables is that the sum of several independent Poisson variables is itself a Poisson variable with a parameter equal to the sum of the parameters of the constituent Poisson variables:

$${Λ}_{G} ( {B}_{G} ) = {\sum }_{i = 1}^{m} {Λ}_{i} ( {B}_{i} )$$

$$and$$

$${F}_{G} ( n ) = P ( {N}_{G} ( {B}_{G} ) < n ) = {\sum }_{i = 1}^{n} \frac{{{Λ}_{Total} ( {B}_{i} )}^{i}}{i !} {e}^{- {Λ}_{T o t a l} ( {B}_{i} )}$$

where B_{G}=Σᵢ₌₁^{m} Bᵢ. (Equation 8). By construction, the Decision Probability (the value sought all along) equals the value of F_{G} (n) where n is the frequency cap value. Substituting into Decision Rule 1, the desired output is obtained:

$${\sum }_{i = 1}^{n} \frac{{{Λ}_{G} ( {B}_{G} )}^{i}}{i !} {e}^{- {Λ}_{G} ( {B}_{G} )} \{ \begin{matrix}> Decision Threshold Bid \\ < Decision Threshold Not Bid\end{matrix}$$

The present invention also allows for real-time updating. The present invention infers the state of the world outside the individual DSP from the available information because during the day the individual DSP is a black box. While the agency 4 receives event logs 3a, 3b from each DSP 2a, 2b at the end of each day (as depicted in FIG. 1, for example) and could therefore act as an information bridge between DSPs 2a, 2b, the agency 4 can only supply information into the DSPs 2a, 2b each beginning of the day in the form of the bid algorithm 5. A more precise calculation of a given user's ad views would require real-time communication between the agency 4 and the multiple DSPs 2a, 2b. Using the probabilistic model of ad views a direct query service 8 (or “Service”) will allow a DSP 2a directly to make an intelligent decision on the likelihood that a given user has hit his or her frequency cap 9 for the day for a given campaign across all DSPs, and therefore whether that particular DSP 2a should fire the ad display bid for that user and that campaign, thus adding value to the client advertisers' ad spend. The Service 8 interacts with the DSP 2a in real time, as follows. First, when a bid opportunity arises (i.e., a bid request 7 is relayed to the DSP 2a from an ad server 6) the DSP 2a asks the Service 8 whether the user identifier has hit its frequency cap for the day 9. Then, the Service 8 runs the probabilistic model discussed above (which may be updated with information that the user is viewing the current property from the current bid opportunity), and determines an updated probability that the user has hit the frequency cap (i.e., whether it is likely that the user has seen a total ad display above the threshold amount or whether it is likely that the user hat not seen a total aid display above the threshold amount). Then, based on the probability determined, the Service 8 returns a “yes/no” response 10 to the DSP 2a (i.e., based on the Decision Threshold set, the DSP now has the ability to respond to the bid request 7 with a bid decision 11). This interaction is shown in FIG. 2.

To provide this information, the DSP provides the user and ad campaign that are the subject of the bid request, and request a yes/no recommendation on firing the bid. Each such bit of information, coupled with the Service's Yes/No recommendation (and an expected link between its recommendation and the likelihood of an ad display) updates the probabilistic model and improve the model's accuracy. The Service thus serves as a real-time information bridge, providing a solution to the segregation of information problem that the probabilistic model is designed to solve. It also serves as a repository of event-based, user-linked behaviors, enabling increasingly precise probabilistic determinations of the fire/do not fire decision

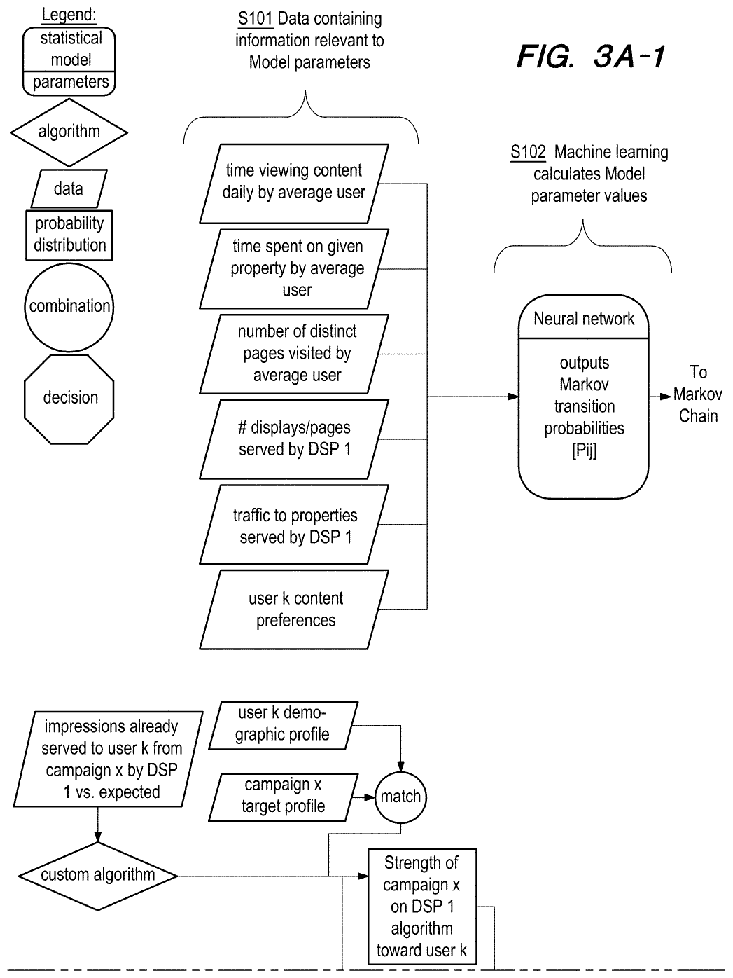

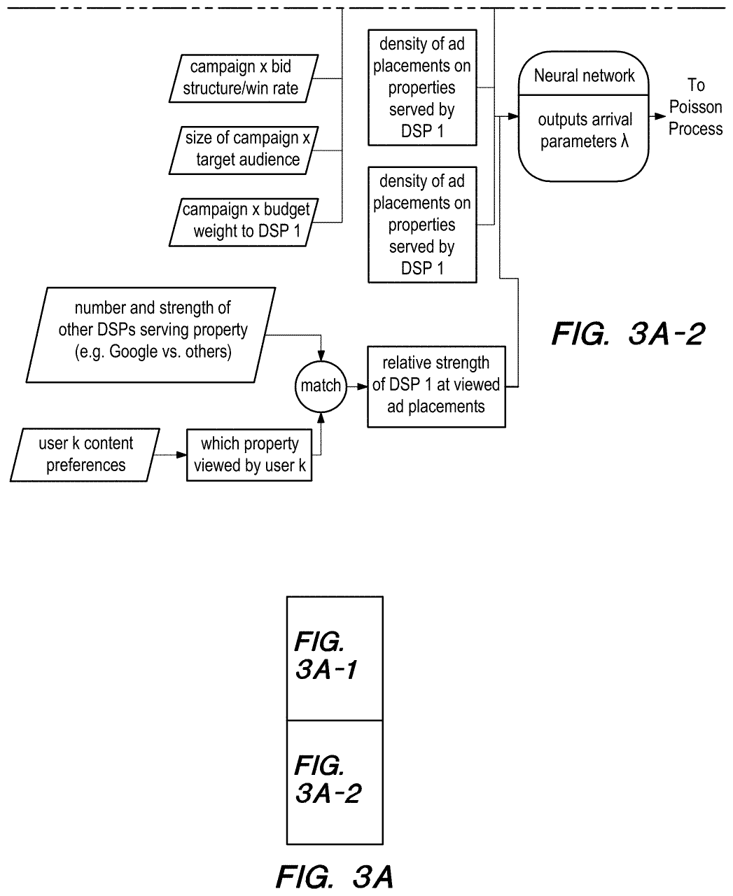

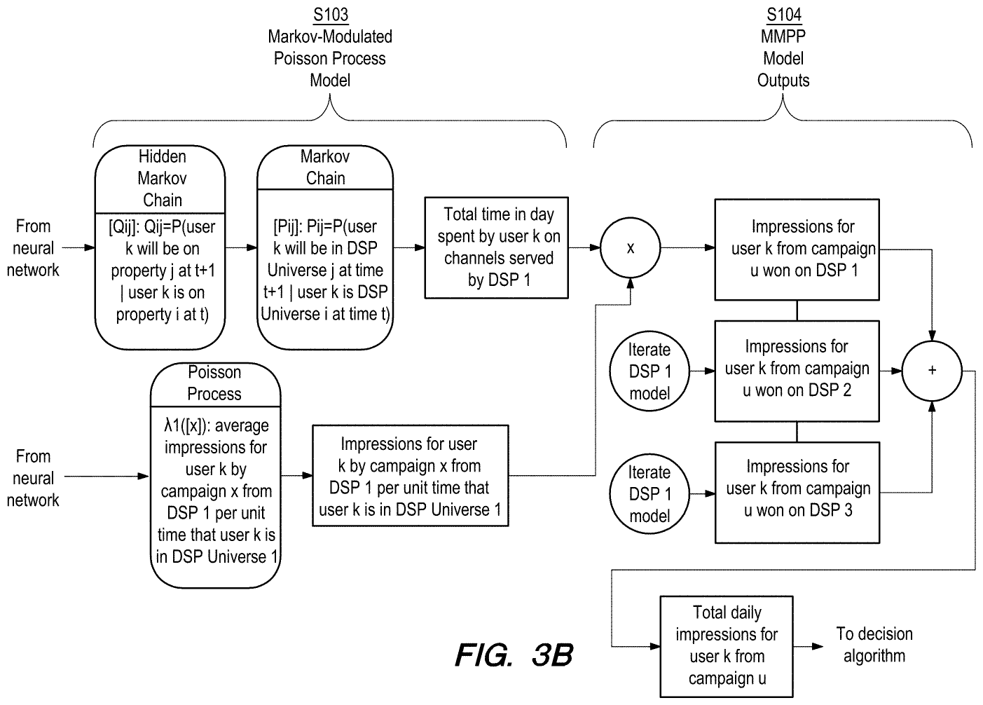

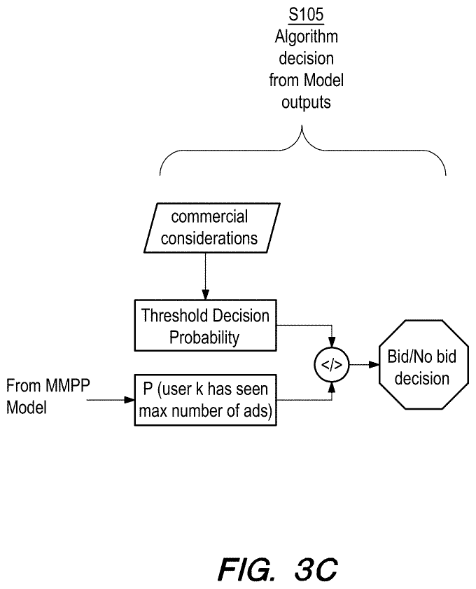

As noted previously, based on the probability of the user visiting digital properties serviced by specific DSPs over time, the amount of time that a user will spend in a state in which it may be exposed to ad impressions processed by each DSP can be modeled using the present invention. Furthermore, the rate at which ad impressions will arrive to the user in each such state can also be modeled. Combining these two models allows for a model of the number of ad displayed to the user by each DSP on a given future day. This model allows for the output of various solutions, depending on operation. In one embodiment, in which the model is run offline, a vector of DSP-specific frequency cap values that result in the optical actual number of total ad impressions across all DSPs can be provided. Alternatively, in a second embodiment, in which the model is run in real-time, a given DSP can update its belief on the expected number of ad impressions that the user has seen elsewhere and accurately halt further bids for impressions to the user when the estimated total number of impressions hits the global cap number. This embodiment is shown, for example, in FIGS. 3A-3C.

As shown, at the left most end of the diagram are the available data sources S101 containing information relevant to producing the model. These data sources are input into two neural networks S102 that produce two sets of statistical parameters that extract the relevant information from the data sources in a suitable format. Then the two statistical models discussed previously, a Markov Chain and a Poisson process, model the user's movement S103 across states corresponding to viewing digital properties served by individual DSPs and the arrival rate of ad impressions while the user is in each such state, respectively, as discussed more fully above. As noted above, these two models together make up the Markov-Modulated Poisson Process (MMPP) previously described. The MMPP output values S104 consist of the expected number of ad impressions on each DSP without a cap. These outputs are utilized to make the bid/no-bid decision S105.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A system useful for selectively making a bid decision for a digital advertising campaign directed toward a target user, the system comprising:
a. a plurality of DSPs in communication with an ad server;
b. at a first of the DSPs, receiving a bid request from the ad server to target a new ad display to the target user;
c. a direct query service in communication with the first DSP, wherein after receiving the bid request the first DSP, the direct query service is configured to:
i. identify a number of seen ad displays the target user has actually seen from the first DSP;
ii. group a plurality of digital properties into a number of universes, wherein each of the universes comprises digital properties served by a single one of the DSPs and for each of the number of universes:
1. determine a probability that the target user is in the particular universe at each moment over a period of time;
2. based on the probability that the target user is in the particular universe at each moment over the period of time, estimate a total amount of time the target user is in the particular universe;
3. determine a rate of ad displays expected to be delivered in the particular universe per moment; and
4. based on the estimated total amount of time the target user is in each universe and the corresponding rate of ad displays expected to be delivered in each universe, calculate a total number of ad displays the target user is expected to have received in the universe over the period of time;
iii. based on the number of ad displays the target user is expected to have received in each universe, estimate the number of expected ad displays the target user is expected to have already seen from the other DSPs;
iv. based on the number of seen ad displays the target user has actually seen from the current DSP and the estimated number of expected ad displays the target user has already seen from other DSPs, calculate a total number of ad displays the target user has likely seen across all DSPs; and
v. determine a probability that the target user has hit a global frequency cap of ad displays by comparing the total number of ad displays the target user has likely seen across all DSPs to the global frequency cap;
wherein the first DSP is further configured to receive from the direct query service the probability that the target user has hit the global frequency cap, and is further configured to respond to the bid request with the bid decision.

2. The system of claim 1, wherein the bid decision is at least one of (a) a bid response if it is determined that the target user has likely not hit the global frequency cap and (b) a no-bid response if it is determined that the target user has likely hit the global frequency cap

3. The system of claim 1, wherein the bid decision comprises a bid amount based on the probability that the target user has hit the global frequency cap

4. The system of claim 3, wherein the bid amount comprises a continuously increasing bid amount for increasingly likely probabilities the target user has not hit the global frequency cap.

5. The system of claim 1, wherein the direct query service is configured to determine the probability that the target user is in the particular universe at each moment over the period of time using a Markov chain analysis.

6. The system of claim 1, wherein the direct query service is configured to determine the rate of ad displays expected to be delivered in the particular universe per moment using a Poisson probability analysis.

7. A method for selectively making a bid decision at a current DSP from a plurality of DSPs based on a determined probability that a target user has not hit a combined frequency cap across all DSPs, the method comprising the steps of:
a. defining the combined frequency cap across all DSPs;
b. receiving a bid request for a new ad display at the current DSP;
c. identifying a number of seen ad displays the target user has actually seen from the current DSP;
d. estimating a number of expected ad displays the target user is expected to have already seen from other DSPs, wherein estimating the number of expected ad displays the target user has already seen from other DSPs comprises the steps of:
i. grouping a plurality of digital properties into a number of DSP universes, wherein each of the DSP universes comprises digital properties served by a single one of the DSPs;
ii. for each of the number of DSP universes, calculating a total expected rate of ad deliveries for the target user for the particular universe, wherein calculating the total expected rate of ad deliveries comprises:
1. determining a probability that the target user is in the particular universe at each moment over a period of time;
2. based on the probability that the target user is in the particular universe at each moment over the period of time, estimating a total amount of time the target user is in the particular universe;
3. determining a rate of ad displays expected to be delivered in the particular universe per moment; and
4. based on the estimated total amount of time the target user is in each universe and the corresponding rate of ad displays expected to be delivered in each universe, calculating a total number of ad displays the target user is expected to have received in the universe over the period of time;
e. based on the number of seen ad displays the target user has actually seen from the current DSP and the estimated number of expected ad displays the target user has already seen from other DSPs, calculating a total number of ad displays the target user has likely seen across all DSPs; and
f. making the bid decision based on the total number of ad displays the target user has likely seen across all DSPs.

8. The method of claim 7, wherein the bid decision is one of (a) a bid response if it is determined that the total number of ad displays the target user has likely seen across all DSPs is lower than the global frequency cap and (b) a no-bid response if it is determined that the total number of ad displays the target user has likely seen across all DSPs is greater than or equal to the global frequency cap.

9. The method of claim 7, wherein the bid decision comprises a continuously increasing bid amount for increasingly likely probabilities the total number of ad displays the target user has likely seen across all DSPs is lower than the global frequency cap.

10. The system of claim 7, wherein the step of determining a probability that the target user is in the particular universe at each moment over a period of time comprises using a Markov chain analysis.

11. The system of claim 1, wherein the step of determining a rate of ad displays expected to be delivered in the particular universe per moment comprises using a Poisson probability analysis.
